(19) United States
(12) Patent Application Publication
(10) Pub. No.: US 2020/0196055 A1
(43) Pub. Date: Jun. 18, 2020

(54) SYSTEM AND METHOD OF USE OF CONNECTING WIRELESS SPEAKERS

(71) Applicant: Positive Outcomes, Inc., Wildwood, MO (US)

(72) Inventor: Ray N. Paslawski, Wildwood, MO (US)

(21) Appl. No.: 16/617,828

(22) PCT Filed: May 29, 2018
(86) PCT No.: PCT/US18/34893

§ 371 Date: Nov. 27, 2019

Related U.S. Application Data
(60) Provisional application No. 62/511,673, filed on May 26, 2017.

(51) Int. Cl. H04R 3/12; H04R 1/02; H04W 4/80

(52) U.S. Cl. CPC H04R 3/12; H04W 4/80; H04R 1/02

(57) ABSTRACT

A connecting wireless speaker and system which includes a speaker housing, a driver, a controller, a power source, and at least one wireless transceiver. The at least one wireless transceiver is capable of being operably linked to a wireless audio transmitting device. The connecting wireless speaker has a male connection port and a female connection port. Each connection port is configured to mate to its opposite connection port making an operable electronic connection between itself and a second speaker having said opposite connection port. Both speakers can be wirelessly connected to the wireless audio transmitting device. The invention also includes methods of using the connecting speakers and systems.

### RELATED APPLICATIONS

This application claims priority to U. S. Provisional Patent Application No. 62/511,673, filed on May 26, 2017, which is hereby incorporated by reference in its entirety.

### STATEMENT REGARDING FEDERALLY SPONSORED RESEARCH

Not applicable.

### BACKGROUND ART

The present invention relates to audio speakers. More particularly, the present invention relates to a system of connecting wireless audio speakers.

The advancement of audio technology has led to the increasing replacement of traditional wired audio speakers with wireless audio speakers. Audio data is transmitted to and received by wireless audio speakers via radio frequency (RF) waves rather than audio cables. As such, wireless audio speakers offer a number of advantages over their wired counterparts, the most obvious being the lack of wires connecting the speakers to the sound system. The lack of visible cables present in an audio speaker system allows for a much more aesthetically pleasing audio system setup and eliminates tripping hazards for the user and anyone walking around the area. Because a conventional wireless speaker set is connected utilizing a public or shared router, proper synchronization amongst the set of speakers is often an issue. Wireless data communication through a public or shared router is often inconsistent and can result in audio signals being delayed and arriving at individual speakers at offset times. Additionally, failure of a transmitter or receiver may result in a dropped signal and reduced quality of a listening experience. The present invention seeks to address the aforementioned issues as well as enhance and improve upon conventional wireless audio speaker systems.

Wireless technologies enable users to reduce the amount of wirings needed to set up equipment. Wireless technologies are widely used in modern electronics. Light emitting diodes (LEDs) provide controllable lighting and solid-state lighting. They consume less power than traditional lighting devices and are environmentally friendly. Over time, LEDs have been widely used in various lighting applications such as lightings in public places, office and indoor lightings, etc. Wireless control of LED lighting devices provides functions such as the ability to remotely switch devices on/off, lighting adjustments, dimming devices, etc. Wireless control of LEDs has been well received by consumers because it is convenient and easy to use.

For traditional speaker systems, however, the fallback position remains to rely on wired connections. These systems are large and often difficult to install. Further, traditional speaker systems often need a separate transceiver to send and receive audio signals and control signals. This type of system configuration may make the speaker system large and expensive to install. As smartphones and other portable devices are being used more widely as control terminals, the issues associated with the traditional set-up for speaker systems has become less acceptable to the typical audio products purchaser.

Nonetheless, known hands free devices also present certain difficulties. For example, devices physically connected to phones by wires can result in the wires getting tangled around seat belts, gear shifts, door handles, chair armrests, and the like. Therefore, wireless hands free devices have been developed. These wireless devices also present certain problems. For example, they require charging separate from the cell phone. The earpiece type devices are not chargeable in use, and are unobtrusive when not in use, therefore, users frequently neglect to keep the earpieces charged. Moreover, switching over from the handset to a speaker operation presents needless additional steps in communication.

Between the aforementioned two wireless audio solutions, Bluetooth, a wireless technology standard for exchanging audio data over short distances, is undoubtedly more universal and has a longer history, from its earliest application in an earphone for Ericsson mobile phones. A predominant advantage of Bluetooth over WiFi is its low power consumption property. In addition, Bluetooth is also excellent in interference immunity and point-to-point communication security. Bluetooth does, however, suffer from some limitations. For one, it has a fairly limited data transfer rate (DTR). Another limitation of Bluetooth is its point-to-point nature, versus, e.g., point-to-multipoint WiFi systems. Additionally, Bluetooth systems can add difficulty by requiring ever-successively paired players to be re-paired for any new connection.

It would be advantageous if a wireless audio system could be developed which maintained the advantages of Bluetooth technology, yet minimized its limitations.

### SUMMARY OF THE INVENTION

Accordingly, a wireless connecting speaker and sound system including multiple wireless connecting speakers joined in a wireless speaker-to-speaker connecting configuration is provided. The system provides for significant space savings, increased sound volume per minimal increased speaker space occupied, and allows for the speakers to be joined together for use and for an easy carry mode.

In one aspect, a wireless connecting speaker is provided including a speaker housing, a driver, a controller, a power source, and at least one wireless transceiver contained therewith. The speaker advantageously has a male connection port and a female connection port, and in preferred embodiments, these are located on generally opposite sides of the speaker housing. Each male/female connection port is configured to mate with its opposite female/male connection port on an abutting speaking, making an operable electronic connection between itself and another speaker having the opposite male/female connection port, and without blocking its opposite mating connection port if it is needed or desired for an additional connection.

In another aspect, a wireless connecting speaker system is provided comprising at least a first and a second wireless speaker as described above, wherein the male connection port of the first speaker is attached to the female connection port of the second speaker or the female connection port of the first speaker is attached to the male connection port of the second speaker.

In yet another aspect, a method of amplifying sound is provided by using the system of speakers as described above and herein.

### BRIEF DESCRIPTION OF THE DRAWINGS

In the accompanying drawings which form part of the specification:

FIG. 1 is a perspective view of a connecting wireless mini speaker according to an embodiment of the present invention;

FIG. 2 is a front view of the connecting wireless mini speaker according to an embodiment of the present invention;

FIG. 3 is a rear view of the connecting wireless mini speaker according to an embodiment of the present invention;

FIG. 4 is a top view of the connecting wireless mini speaker according to an embodiment of the present invention;

FIG. 5 is a bottom view of the connecting wireless mini speaker according to an embodiment of the present invention;

FIG. 6 is a right end view of the connecting wireless mini speaker according to an embodiment of the present invention;

FIG. 7 is a left end view of the connecting wireless mini speaker according to an embodiment of the present invention;

FIG. 8 is a perspective view of a pair of connecting wireless mini speaker in a connected arrangement;

FIG. 9 is a top view of the pair of connecting wireless mini speaker in a connected arrangement;

FIG. 10 is a front view of the pair of connecting wireless mini speaker in a connected arrangement.

FIG. 11 is an exploded view of the connecting wireless mini speaker according to an embodiment of the present invention showing various component parts in this embodiment; and,

FIG. 12 is a perspective view of four connecting wireless mini speakers in a connected arrangement.

Corresponding reference numerals indicate corresponding parts throughout the several figures of the drawings.

### DETAILED DESCRIPTION

The following detailed description illustrates the claimed invention by way of example and not by way of limitation. The description enables one skilled in the art to make and use the disclosure, describes several embodiments, adaptations, variations, alternatives, and uses of the disclosure. Additionally, it is to be understood that the disclosure is not limited in its application to the details of construction and the arrangements of components set forth in the following description or illustrated in the drawings. The disclosure is capable of other embodiments and of being practiced or being carried out in various ways. Also, it is to be understood that the phraseology and terminology used herein is for the purpose of description and should not be regarded as limiting.

Applicant has developed a wireless speaker-to-speaker connecting system which, as developed, maintains the above-mentioned advantages of Bluetooth technology, and minimizes the above-noted limitations. Applicant's system adds at least the further advantages of providing significant spatial savings, increased sound volume for minimal speaker area, and an easy mode for carrying the speakers as a compact unit.

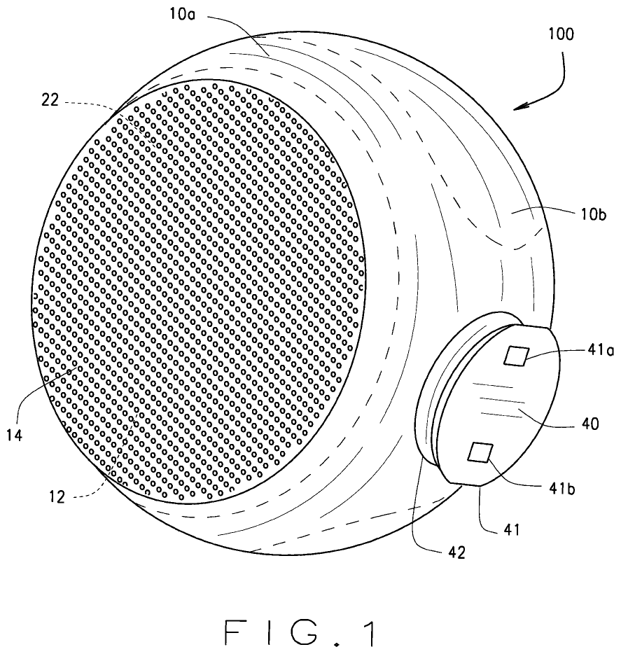

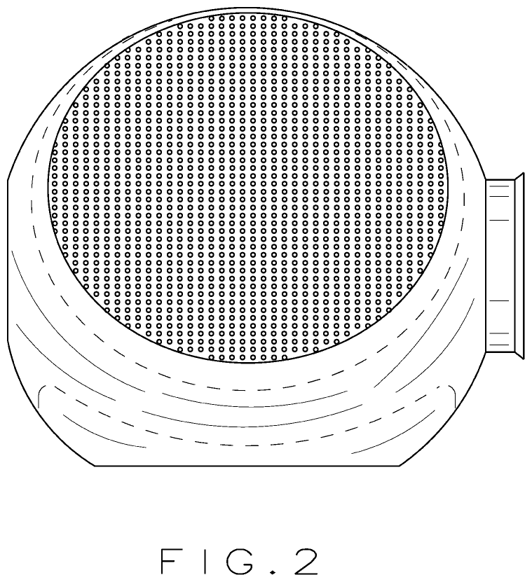

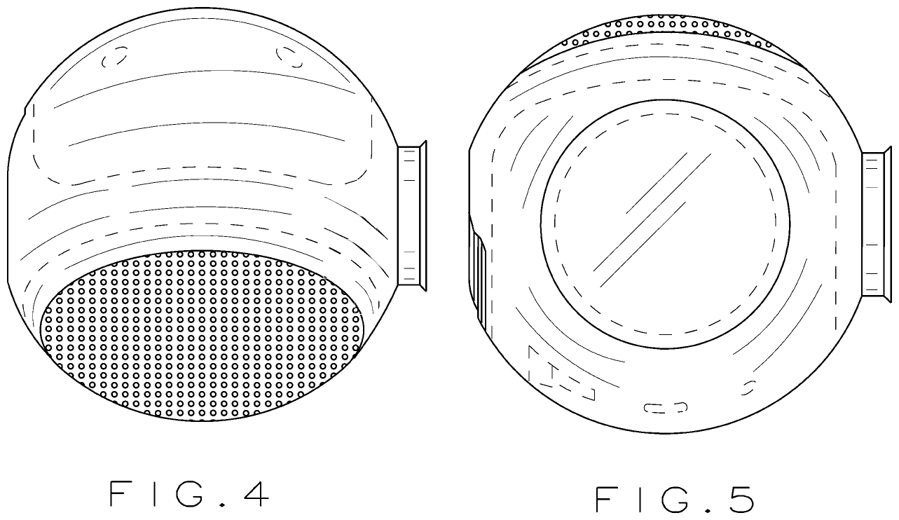

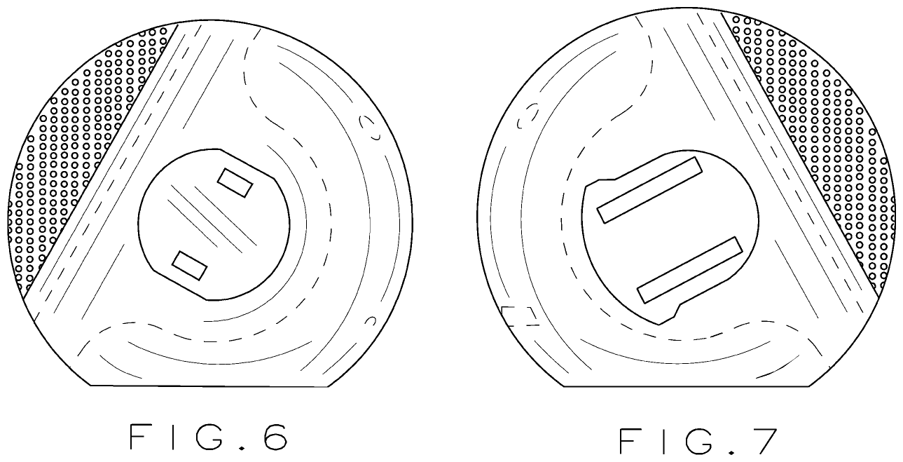

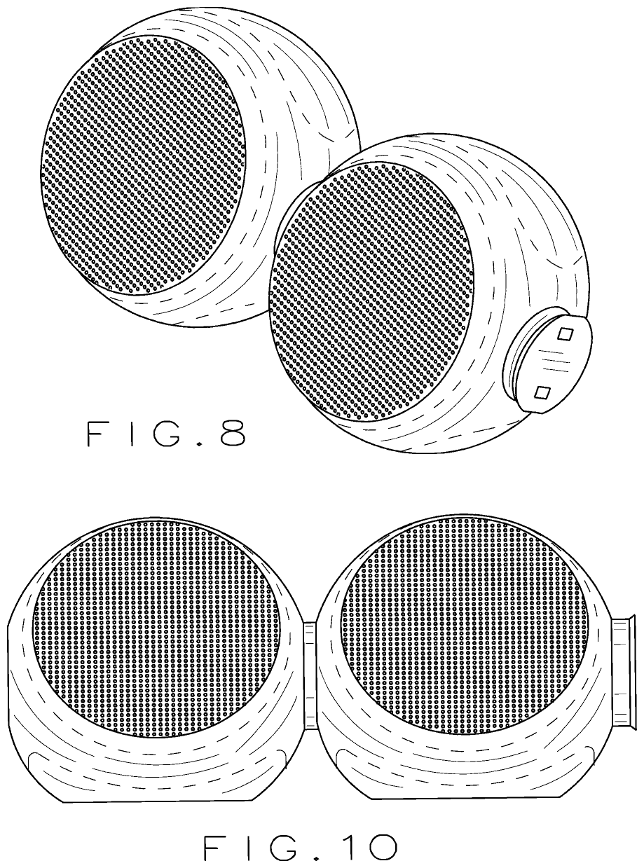

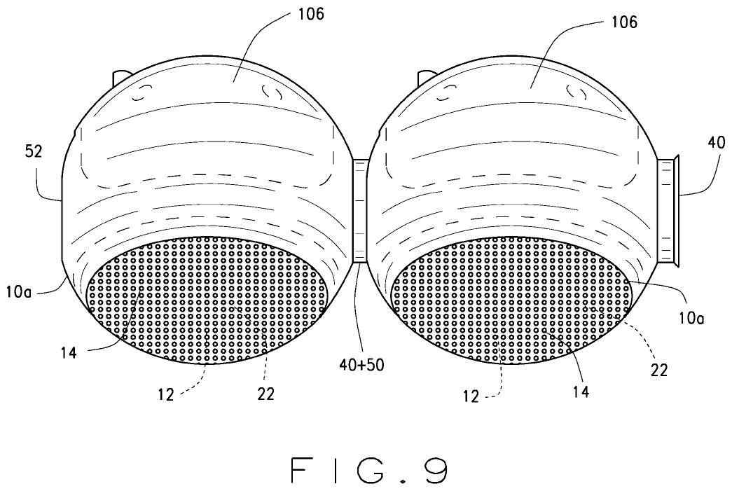

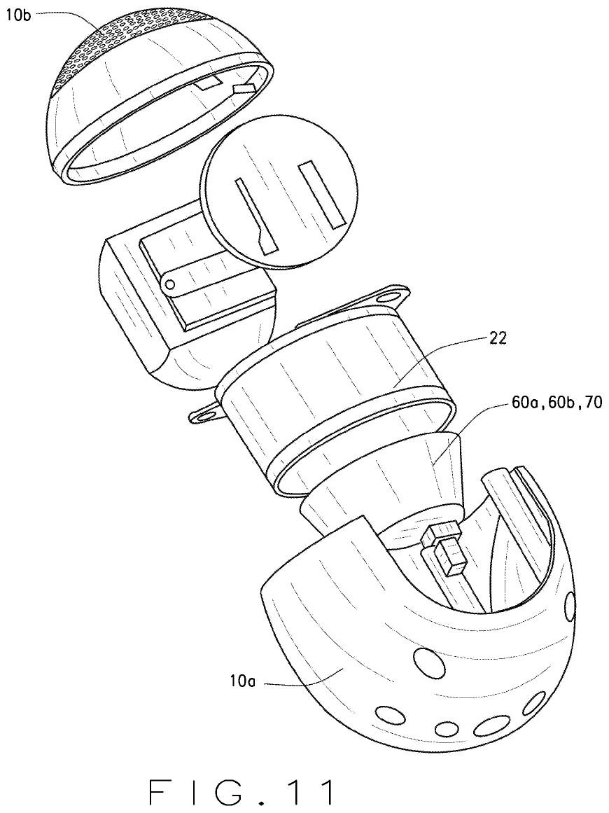

As shown in FIGS. 1-10, an embodiment constructed in accordance with the present disclosure is shown, generally referred to as a speaker-to-speaker connection-ready wireless speaker 100.

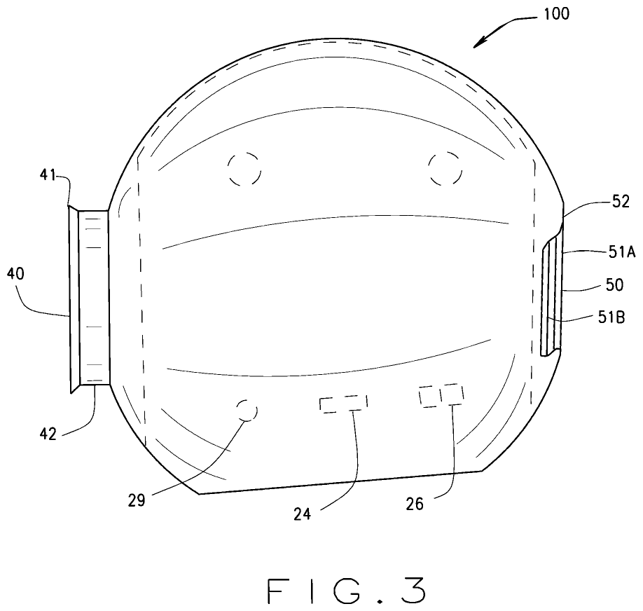

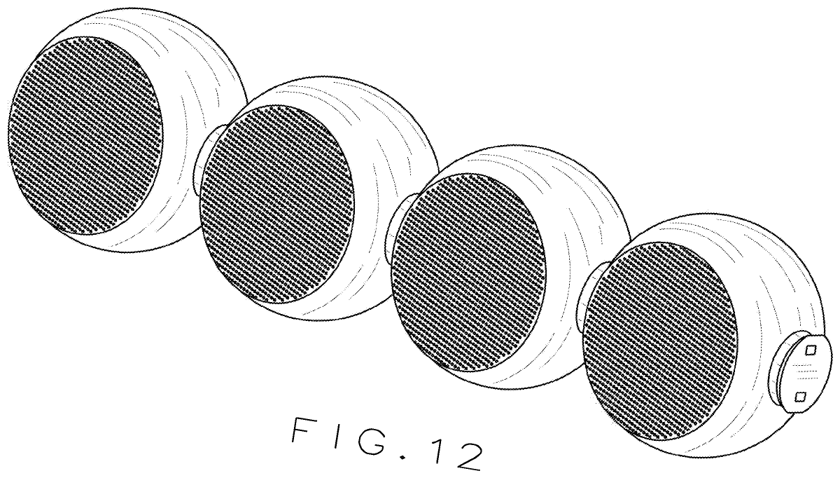

As shown in FIG. 1, the speaker 100 includes a speaker housing 10, including in this embodiment a front half-spherical portion 10a mated to a back half-spherical portion 10b. Carved out of the front speaker housing 10a is a generally concave space for seating the speaker driver 12 (best seen in FIG. 11) which is covered by a convex-shaped semi-spherical grill 14 which fills in the exterior portion of the housing in which the speaker driver sits. Thus, as completed by the speaker housing 10 and grill 14, the exterior of the speaker 100 is largely spherical as a whole, with the exception of male and female connecting units, which are discussed below. As best shown in FIG. 3, a charging indicator light 20 is operably connected to an interior rechargeable battery (a Lithium-ion battery of 3.7 V, 300 mAh in this embodiment) 22. The indicator light 20 will show as a red light as long as the battery is charging, which extinguishes when no longer being charged. In this embodiment, when the battery charge falls below a certain minimum level, it will signal that a charge is needed by triggering a recorded voice to state: “low battery, please recharge”. Next to the indicator light is the USB (Universal Serial Bus) power supply/recharging port 24 which may connect to a power source (e.g., a Portable Computer with a matching USB port via, e.g., a micro USB to USB cable 30. As also shown in FIG. 3, the speaker 10 has a control switch 26, which may have a number of functionalities. In the illustrated embodiment, the switch can occupy three positions; an Aux (Auxiliary) position, an “Off” position, and a BT (Bluetooth) position.

As mentioned above, and as shown in various Figures (see, e.g., FIG. 1), the speaker 100 contains a male connection port 40 which has a somewhat annular rim 41 largely rigid, but with some give so as to be configured to slide snugly into a substantially-circular slot 51 of a female connection port 50 which is also constructed of material to be largely rigid, but with some give so that when the rim of the male port's rim can be pushed into the female connection port's slot to form a snug, but, with sufficient force, a removable fit. (See various Figures which show Speaker A mated on its male side with Speaker B on its female side). When so mated, metal contacts 41a, 41b located at an open end 42 of the male connection port 40 line up with metal contacts 51a, 51b located at an open end 52 of the female connection port 50 and form an operable electronic connection between Speaker A and Speaker B.

The connecting speakers of the illustrated embodiment of the invention may have a first wireless transceiver 60a which may receive digital audio signals and controlling signals from a smart terminal. The first wireless transceiver 60 may then send the received data to a control unit 70 which may be located inside the housing 10 inside the wireless connecting speaker 100. The control unit 70 may process digital audio signals, and may send the processed digital audio signals to a second wireless transceiver 60b. In this embodiment, one of the wireless transceivers 60a or 60b may send the received digital audio signal to an audio codec unit 80. The audio codec unit 80 may code/decode the received audio signals, and may send the processed audio signals to an audio power amplifier 90. The audio codec unit 80 may be connected to the second wireless transceiver 60b. The control unit 70 may send feedback information to the smart terminal through the first wireless transceiver 60a. The first wireless transceiver 60a may also be connected to the second wireless transceiver 60b.

Further, the control unit 70 may process the received audio signals using various algorithms. The control unit 70 may be a microprocessor, a digital processor, a digital integrated circuit (IC), or a combination thereof. The first wireless transceiver 60a may receive digital audio signals and controlling signals from the smart terminal and send the received signals to the control unit 70. The control unit 70 may process the digital audio signals and control signals, and send the processed signals to the audio power amplifier 90 and the first wireless transceiver 60a. The audio power amplifier 90 may be connected to the speaker driver 12. The control unit 70 may communicate with the second wireless transceiver 60b. The control unit 70 may also use the second wireless transceiver 60b to communicate with other devices.

In some embodiments, the first wireless transceiver 60a and second wireless transceiver 60b may support frequency bands such as 2.4 GHz, 5.2 GHz, 5.8 GHz, and other working frequencies or the combinations thereof. They may be capable of both receiving and sending data. They may be operably connected to the internet or a local area network to realize remote control of multifunctional devices.

In preferred embodiments, the connecting speaker 100 is wirelessly paired with an electronic device, such as a cellular phone, a laptop, a portable music player, or the like, typically by any known wireless communication interface, such as a Bluetooth® network, for transmission of audio signals between the electronic device and the speaker 100. The present invention is especially adapted for playing music stored on or broadcast via an electronic device through speakers 100. See Speakers A and B, especially of a conveniently small size which take up very limited space and provide for significant ease of carry. Additionally, the present invention is especially suitable for using a cellular phone in a hands-free manner whereby a user can transmit music, vocal dialog, or other auditory output through the phone via the speakers 100 of the invention using a wireless interface with the speakers 100, while using the connecting functionality of the speakers to provide greater volume and more enhanced sound quality than speakers connected only via wires, or even only wirelessly.

Alternate power connectors may be used for the power conversion interface with the speakers 100 of the invention, without departing from the spirit and principles of the present invention. For example, the speaker 100 may be provided with a plug for connection to a wall socket. As mentioned above for one embodiment, the housing may be provided with a power input port, such as a micro-USB port. Alternatively, power may be supplied via a regular USB PORT, a mini-USB port, an AC/DC power input jack, or the like, whereby the power supply port 24 can be connected to the external power source using an appropriate connector or power cord such as the USB micro-cable 30 as described above.

In an illustrated embodiment, in general, Bluetooth-enabled devices may have wireless capabilities and the various embodiments of the device can include, but are not limited to, cellular telephones, personal digital assistants (PDAs), portable computers, music storage and playback appliances, Internet appliances permitting Internet access and browsing, as well as portable units or terminals that incorporate combinations of such functions.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto.

In use, according to an illustrated embodiment, prior to using the Bluetooth connecting speaker, the rechargeable lithium ion battery is charged fully. During this charging phase, the control power switch 26 should be placed in its Off position. In this embodiment, the micro-USB plug 30a should be connected to the micro-USB charging port 24 to charge the battery 22.

In the illustrated embodiment, with the battery fully charged, the control power switch 26 is moved to the BT position, which will turn the speaker's power on. The Bluetooth enabled cell phone or other media device may then be manually paired together to establish the Bluetooth connection. In this embodiment, the volume on the media device may be adjusted to a desired level and a music selection chosen.

Changes can be made in the above constructions without departing from the scope of the disclosure. For example, the shape and size of the speakers may be changed. The nature of the connections between the speakers may be reconfigured as long as they provide the operable electronic linkage between two or more speaker units. Moreover, another wireless connection, such as a different version of Bluetooth, Wi-Fi, or other wireless technology may be adapted to use the connecting speakers of the instant invention. Thus, it is intended that all matter contained in the above description or shown in the accompanying drawings shall be interpreted as illustrative and not in a limiting sense.

1. A connecting wireless speaker comprising a speaker housing, a driver, a controller, a power source, and containing at least one wireless transceiver, wherein the at least one wireless transceiver has the capability to be operably linked to a wireless audio transmitting device, wherein the connecting wireless speaker has a male connection port and a female connection port, each being configured to mate to its opposite connection port making an operable electronic connection between itself and a second speaker having said opposite connection port, whether it be the male connection port or the female connection port.

2. The connecting wireless speaker of claim 1 wherein the power source is a rechargeable battery.

3. The connecting wireless speaker of claim 1 wherein the wireless audio transmitting device and the connecting wireless speaker are each Bluetooth compatible devices.

4. The connecting wireless speaker of claim 1 wherein the male connection port has a flange or rim configured to fit snugly, yet removably, within a substantially annular slot of the female connection port of the second speaker.

5. The connecting wireless speaker of claim 1 wherein the connecting wireless speaker has a maximum diameter in any direction of less than about 7 inches.

6. The connecting wireless speaker of claim 1 wherein the speaker is largely spherical in shape.

7. A connecting wireless speaker system comprising at least a first and a second wireless speaker wherein each of the at least first and second wireless speakers comprises a speaker housing, a driver, a controller, a power source, and contains at least one wireless transceiver, wherein the at least one wireless transceiver has the capability to be operably linked to a wireless audio transmitting device, wherein the at least first connecting wireless speaker has a male connection port and a female connection port, each being configured to mate to its opposite connection port making an operable electronic connection between itself and the second wireless speaker having said opposite connection port.

8. The connecting wireless speaker system of claim 7 wherein the male connection port of the first wireless speaker is attached to the female connection port of the second wireless speaker or the female connection port of the first wireless speaker is attached to the male connection port of the second wireless speaker.

9. The system of claim 8 wherein the system comprises at least four speakers connected in a configuration of alternating male and female connection ports.

10. A method for amplifying sound, the method comprising obtaining multiple connecting speakers having connecting male and female connection ports, connecting the multiple connecting speakers in a manner whereby the male connection port of one speaker is attached to the female connection port of another connecting speaker and so forth until a predetermined number of speakers has been connected and creating a system of interconnected speakers, connecting the system of interconnected speakers to a power source, turning on the system of interconnected speakers and wirelessly connecting the system of interconnected speakers to a wireless audio transmitting device.

11. The method of claim 10 wherein the male connection port of the first wireless speaker is attached to the female connection port of the second wireless speaker or the female connection port of the first wireless speaker is attached to the male connection port of the second wireless speaker.

12. The method of claim 10 wherein the system comprises at least four speakers connected in a configuration of alternating male and female connection ports.

13. The method of claim 10 wherein the power source is a rechargeable battery.

14. The method of claim 10 wherein the wireless audio transmitting device and the multiple connecting speakers are Bluetooth compatible devices.
